(19) United States
(12) Patent Application Publication
(10) Pub. No.: US 2026/0010378 A1
(43) Pub. Date: Jan. 8, 2026

(54) ENHANCED BOOT SEQUENCE USING MULTI-CORE APPLICATION IMAGES

(71) Applicant: TEXAS INSTRUMENTS INCORPORATED, Dallas, TX (US)

(72) Inventors: Tanu Hari Dixit, Bangalore (IN); Rajesh Vanga, Bangalore (IN)

(21) Appl. No.: 19/092,968

(22) Filed: Mar. 27, 2025

(30) Foreign Application Priority Data
Jul. 5, 2024 (IN) 202441051533
Jul. 24, 2024 (IN) 202441056270

(51) Int. Cl. G06F 9/4401; H04L 9/14

(52) U.S. Cl. CPC G06F 9/4401; H04L 9/14

(57) ABSTRACT

In an example embodiment, a method is provided for combining multiple application images into a combined application image for improved boot processes. The method includes identifying multiple application images corresponding to multiple processing cores of a computer system, each including a set of application code segments corresponding to a respective processing core of the multiple processing cores, generating a combined application image based on the multiple application images, the combined application image including a set of application code segments corresponding to the set of application code segments of each application image of the multiple application images, and a mapping segment indicative of correlations between the set of application code segments of the combined application image and the set of application code segments of each application image, and storing the combined application image on an external memory external relative to the computer system.

### CROSS-REFERENCE TO RELATED APPLICATIONS

This application claims the priority benefit of India Provisional Patent Application No. 202441056270, filed Jul. 24, 2024, entitled “METHOD TO OPTIMIZE SECURE BOOT PERFORMANCE ON MICROCONTROLLERS AND MICROPROCESSORS,” and India Provisional Patent Application No. 202441051533, filed Jul. 5, 2024, entitled “METHOD TO OPTIMIZE SECURE BOOT ON MEMORY CONSTRAINED PROCESSORS AND MICRO-CONTROLLERS,” both of which are hereby incorporated by reference in their entirety.

### TECHNICAL FIELD

This relates generally to booting of a computer system, and in particular, a computer system including multiple processing cores.

### BACKGROUND

A computer system includes processing cores to run software programs by reading program instructions from memory and then executing them to perform various functions associated with the software. In some systems, the program instructions are often stored in non-volatile memory, whereas the memory on which the program instructions are executed is a volatile memory. Due to the increasing size and complexity of software programs, the non-volatile memory may be external to the computer system, whereas the volatile memory may be an internal memory on-chip of the computer system.

In booting, when a computer system includes multiple processing cores, each processing core executes a corresponding portion of the program instructions. Thus, when loading program instructions from external memory to internal memory, the program instructions are generally stored in a temporary location in the internal memory. Then, in the internal memory, the program instructions are parsed to determine the individual portions of the program instructions corresponding to the respective processing cores, which will then be moved from the temporary location into specific locations within the internal memory known to the processing cores for execution. Problematically, this requires internal memory capacity to be significantly larger than the actual size of the software program. This can effectively reduce the capacity of the internal memory, sometimes even by 50%.

Some computer systems require booting with a security mechanism. In those systems, security checks are often performed on the program instructions to verify the integrity and authenticity of the program instructions. During the security check, the processing cores may have to wait idly before they can proceed to next operations, e.g., loading a next portion of the program instructions from the external memory and/or execute the next portion of the program instructions afterwards. This can cause delays to the boot sequence and thus reduce performance of the computer system.

### SUMMARY

The technology described herein includes processing devices, systems, and methods of operation that improve boot processes related to the booting of a computer system. More specifically, the boot process is improved based on combining multiple application images into a consolidated, combined application image that can be loaded into corresponding specific locations in memory. Then, the combined application image can be streamed to a security module of the computer system, thereby saving memory capacity requirements and increasing processing efficiency cost without sacrificing security.

In an example embodiment, a method is provided for combining multiple application images into a combined application image for improved boot processes. The method includes identifying multiple application images corresponding to multiple processing cores of a computer system, each including a set of application code segments corresponding to a respective processing core of the multiple processing cores, generating a combined application image based on the multiple application images, the combined application image including a set of application code segments corresponding to the set of application code segments of each application image of the multiple application images, and a mapping segment indicative of correlations between the set of application code segments of the combined application image and the set of application code segments of each application image, and storing the combined application image on an external memory external relative to the computer system.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system in an implementation.

FIG. 2 illustrates an application image combination method in an implementation.

FIG. 3 illustrates an example operating environment in an implementation.

FIGS. 4A and 4B illustrate example boot methods in an implementation.

FIGS. 5A and 5B illustrate an example operational scenario with respect to a boot sequence in an implementation.

FIGS. 6A and 6B illustrate an example operating environment in an implementation.

FIG. 7 illustrates an example boot method in an implementation.

FIG. 8 illustrates an example operational scenario with respect to a boot sequence in an implementation.

FIGS. 9A and 9B illustrate example graphical representations of outputs produced by elements of a system in an implementation.

FIG. 10 illustrates an example operating environment in an implementation.

FIG. 11 illustrates a computing system suitable for implementing the various systems, operational environments, architectures, environments, methods, processes, scenarios, sequences, and frameworks discussed below with respect to the other Figures.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Technology is disclosed herein that mitigates the problems discussed above with respect to memory capacity requirements and delays in the boot sequence of computer systems. In some embodiments, the computer systems may include systems including general purpose or application specific processing cores, microcontroller units, microprocessor units, embedded systems, etc. The boot sequence may include loading of software program (hereinafter “an application image” in this disclosure) from a first memory (e.g., an external memory) to a second memory (e.g., an internal memory) and executing the software program, with or without a security mechanism. More specifically, such operations include reading program instructions from read-only memory (ROM), executing secondary bootloader (SBL) code, and verifying the authenticity of program instructions related to an application image, or software program, to be executed during run-time operations of the system.

As described above, in various embodiments, a computer system disclosed herein may include multiple processing cores, where each processing core may require an application image for booting. Thus, in various embodiments, the individual application images may be combined into a consolidated, combined application image that may be used by the computer system for the boot sequence. Additionally, the combined application image may include a mapping segment to indicate a mapping of the segments of the original application images to the segments of the combined application image. In some embodiments, the mapping segment may further include information indicating a boot sequence by which the set of application code segments of the combined application image is executed by the multiple processing cores, e.g., which processing cores is to execute a corresponding portion of the combined application image to boot first, which processing core is to execute a corresponding portion of the combined application to boot next, etc. Further, in some embodiments, the computer system may load and execute the combined application image in a streaming manner, with or without a security mechanism.

In various embodiments, the computer system may include a hardware security module, in addition to the processing cores, to implement the boot sequence with the security mechanism. The hardware security module may perform security checks (e.g., authentication, hashing operations, and/or other cryptographic operations). As described above, in some embodiments, the security checks may cause idling of the processing cores and slow down the boot sequence. Thus, one or more alternative boot sequence will be described to allow loading of the combined application image by the processing cores in parallel with the security checks by the hardware security module. The parallel operations may greatly reduce the delays of the boot sequence and thus improve efficiency and performance of the computer system.

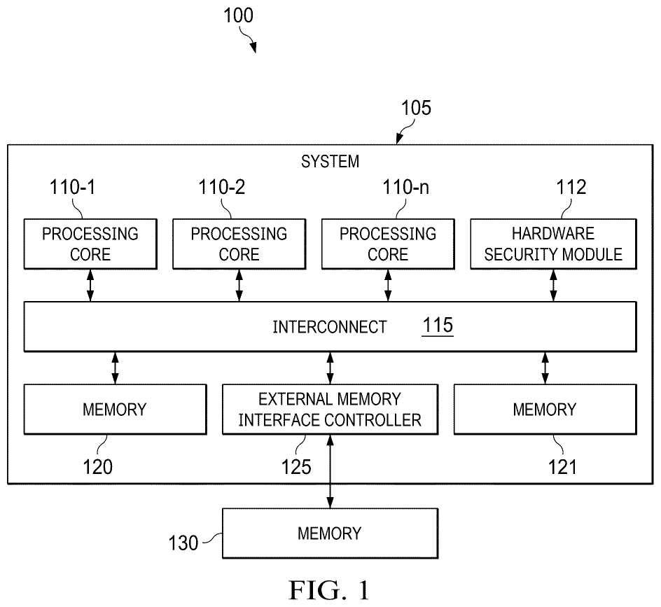

Turning now to the drawings, FIG. 1 illustrates system 100, which includes system 105 and memory 130. System 105 includes processing cores 110-1 through 110-n (collectively processing cores 110), hardware security module 112, interconnect 115, memory 120, memory 121, and external memory interface controller 125.

In various embodiments, system 100 is representative of a computer system that includes various hardware, software, and firmware elements. Some elements of system 100 may be onboard a chip (e.g., a system-on-a-chip (SoC), an integrated circuit (IC), and the like), while some elements may be located off-chip relative to other elements. For example, processing cores 110, HSM 112, memory 120, and memory 121, and other components of system 100 may reside on system 105 (e.g., an SOC), whereas memory 130, among other external memory devices, peripheral devices, and the like, may be off-chip outside system 105.

System 105 may be representative of a computer device or system, such as a microcontroller unit (MCU), a microprocessor unit (MPU), or another type of embedded system, as well as a general processing unit, graphical processing unit, and more. In various embodiments, system 105 includes processing cores 110 and memories 120 and 121 from which processing cores 110 read data and write data during operation. Processing cores 110 are representative of one or more processors, processing cores, or processing circuitry capable of executing software and firmware, such as program instructions (e.g., application code, loadable instructions, read-only data, execute-in-place XIP) code, and the like). Examples of such processor(s) may include microcontrollers, digital signal processors (DSPs), general purpose processing units, central processing units (CPUs), application specific processors or circuits (e.g., ASICs), and logic devices (e.g., FPGAs), as well as other types of processing devices, combinations, or variations thereof.

Hardware security module 112 is representative of a processing core, hardware accelerator, circuit, or other processing device configured to perform security operations (e.g., hashing, cryptography) on data being read from memory 130 by one or more of processing cores 110. In various embodiments, the data (e.g., a combined application image) may first be read from memory 130 by processing cores 110 and stored in memory 120. Then HSM 112 may access the data from memory 120 to perform the security operations. In various embodiments, upon initialization of hardware security module 112, hardware security module 112 performs security operations on an application image. For example, HSM 112 may perform hashing operations on segments of the combined application image to determine a combined hash, which is then compared with an expected hash to authenticate the content of the combined application image. Additionally, HSM 112 may decrypt segments of the combined application image prior to allowing processing cores 110 to execute the program instructions. If HSM 112 fails to complete the security operations, hardware security module 112 provides a failure indication to abort the boot sequence. Addition details related to hardware security module 112, security operations, functional safety operations, and the like can be found in related patent application Ser. No. 18/448,432, filed on Aug. 11, 2023, entitled “HARDWARE SECURITY MODULE FIRMWARE,” which is hereby incorporated by reference.

Memories 120 and 121 are representative of computer-readable storage media located on-chip. Examples of memories 120 and 121 include but are not limited to random access memory (RAM), tightly-coupled memory (TCM), or other types of volatile memory as well as combinations and variations thereof. As described in detail below, in various embodiments, memory 120 and 121 may be used to expedite the boot sequence, e.g., by allowing in-parallel image loading by processing cores 110 with security operations by HSM 112. While shown as individual blocks in system 105, memories 120 and 121 may be implemented as a single memory device functioning in an integrated manner.

Some program instructions executable by processing cores 110 may be initially stored in one or more external memory devices, such as memory 130 (e.g., non-volatile memory or volatile memory) and copied to memory 120 and/or memory 121 for execution by processing cores 110. Additionally, some program instructions (e.g., execute-in-place code) stored on memory 130 may be executed directly out of memory without first being copied to either memory 120 or memory 121. Memory 130 may be representative of off-chip volatile (e.g., RAM) or non-volatile memory. Examples of non-volatile memory include, but are not limited to, flash memory, non-volatile RAM (NVRAM), erasable programmable read-only memory (EPROM), and electrically erasable programmable ROM (EEPROM). In some embodiments, system 100 may include additional external memory devices each of the same or different type of memory.

In various embodiments, processing cores 110 request access to one or more of the memory devices via access requests. Access requests refer to input-output (I/O) operations, such as read operations and write operations. To read or write from memory 120 or memory 121, processing cores 110 may directly access the memory devices via interconnect 115. To read or write from memory 130, however, processing cores 110 may utilize external memory interface controller 125 to interface with memory 130.

External memory interface controller 125 is representative of a memory interface controller capable of interfacing with memory 130 based on access requests provided by processing cores 110. External memory interface controller 125 may be a non-volatile memory interface controller natively configured to read from and write to non-volatile memory devices. In particular, in some embodiments, external memory interface controller 125 supports various types of interfaces, including serial interfaces (e.g., OSPI, QSPI, xSPI, LP4) and/or parallel interfaces.

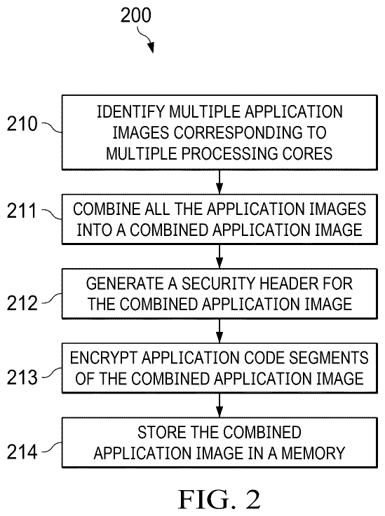

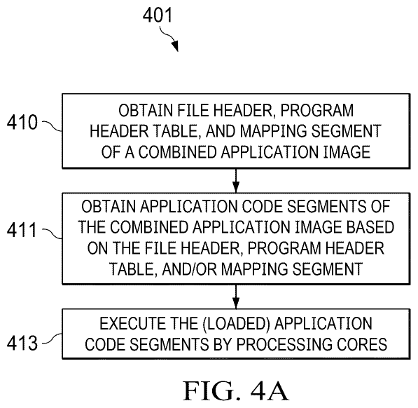

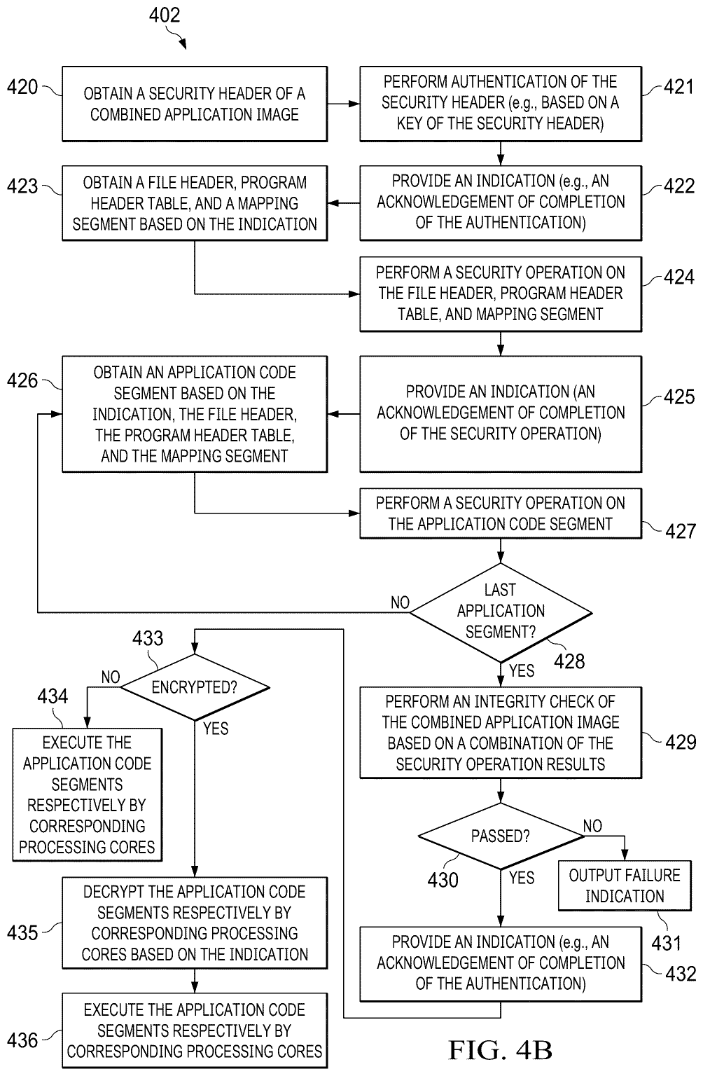

FIG. 2 illustrates method 200 for creating a combined application image. FIGS. 4A and 4B illustrate methods 401 and 402, respectively, for loading and executing the combined application image in different boot sequences.

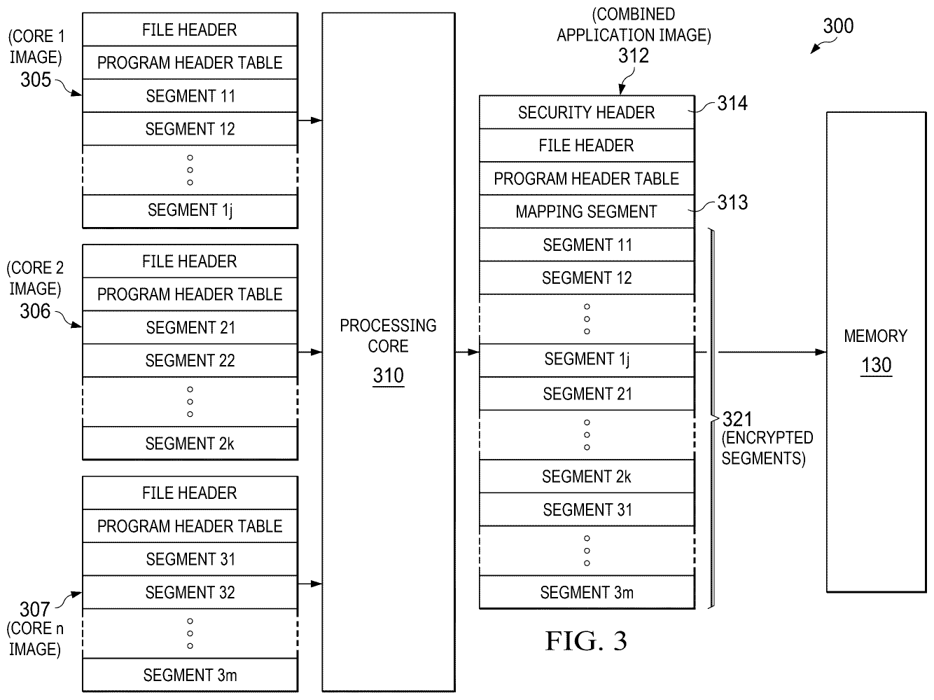

Referring now to FIG. 2, method 200 may be performed by a computer system (e.g., a computer system including processing core 310 of FIG. 3), such as a computer system utilized by a user to develop an application image. In various embodiments, the computer system used to develop the application image may be different from the computer system used to load and execute the application image. For example, the formal may be a laptop computer, a desktop computer, or a mobile device that a user uses to develop the software program, whereas the latter may be a microcontroller system that loads and runs the software program. To distinguish, the first computer system is also called “source system” and the second computer system is also called “destination system” or “host system” in this disclosure. In some embodiments, method 200 may be implemented in logic in the context of hardware elements, or in program instructions in the context of software and/or firmware elements. For the sake of simplicity, the following discussion references a processing core as the element performing method 200, referring to the steps in FIG. 2.

In operation 210, a processing core of the source system receives and identifies multiple application images corresponding to multiple processing cores 110. Each application image may include a set of program instructions (also referred to as application code segments) to be executed by a corresponding processing core of system 105. In some embodiments, the application images may be in a file format standard, such as an Executable and Linkable Format (ELF) format.

In operation 211, the processing core combines all the application images into a single, consolidated application image. Accordingly, the combined application image includes the original program instructions of those individual application images. In various embodiments, the combined application image may use a standard file structure, e.g., an Executable and Linkable Format (ELF) format. For example, the content of the combined application image may be divided into “segments” according to the ELF format. In some embodiments, the combined application image may include a file header, a program header table (PHT), and segments of program instructions (hereinafter the “application code segments”). The file header may include data and/or information about the combined application image, such as magic number, file class (e.g., 32-bit, 64-bit, etc.), file type (executable, shared object, relocatable, etc.), machine architecture (e.g., x86, ARM, etc.), locations of segments of the ELF file (e.g., the offset and size of the PHT, etc.). The program header table (PHT) may include data and/or information describing segments of the combined application image that are relevant for program execution, e.g., the offsets and sizes of the application code segments, the specific locations where the application code segments are to be stored after loading, the correspondence of each application segment to a respective processing core, etc. In various embodiments, the combined application image may optionally include a security header. The security header may include security related information, such as a symmetric key associated with symmetric encryption, a public key associated with asymmetric encryption, etc. Sometimes, the security header, the file header, and the PHT may be viewed as “headers” of an ELF file, because they do not include the application code related to program execution and need to be parsed first before a destination or host system is able to load and execute the application code segments. Additionally, the combined application image may further include a mapping segment, which may include data and/or information indicative of a mapping of the application code segments of the original application images to the application code segments of the combined application image. In some embodiments, the mapping segment may further include data and/or information indicative of a boot sequence of the multiple processing cores 110, e.g., which processing cores is to execute a corresponding portion of the combined application image to boot first, which processing core is to execute a corresponding portion of the combined application to boot next, etc.

In operation 212, the processing core may optionally generate a security header for the combined application image. In various embodiments, the security header is representative of a security certificate (e.g., an X509 certificate) usable to determine the integrity of the combined application image. In some examples, the security header may include a signature with an asymmetric key (e.g., RSA-4K, ECDSA). Additionally, in some examples, the security header includes an integrity value calculated by performing one or more hashing algorithms (e.g., SHA2-256, SHA2-512) on one or more other segments of the combined application image.

Next, in operation 213, the processing core may encrypt the application code segments (e.g., segments of program instructions) of the combined application image. In various embodiments, encrypting the application code segments entails performing one or more encryption algorithms (e.g., AES-CBC, AES-GCM) on the sections of the application image that include program instructions executable by corresponding processing cores. Further, in some embodiments, the encryption step does not entail performing the encryption algorithms on other sections of the application image such as the file header, the PHT, and/or the mapping segment. In some examples, the encryption of the application code segments is optional.

Lastly, in operation 214, the processing core stores the combined application image in a memory, e.g., memory 130 which can be accessed by processing cores 110 of the destination or host system 105 via external memory interface controller 125.

FIG. 3 illustrates operating environment 300 including example elements capable of implementing application image combination processes, such as those of method 200. In particular, operating environment 300 includes processing core 310 of a source system that receives numerous application images, generates combined application image 312, and stores the combined application image 312 on a memory, e.g., memory 130.

In FIG. 3, operating environment 300 shows processing core 310 receiving core images 305, 306, and 307. As described above, processing core 310 is representative of one or more processors, processing cores, or processing circuitry of a source computer system that are capable of executing software and firmware, such as program instructions (e.g., application code, loadable instructions, read-only data, execute-in-place XIP) code, and the like). Examples of such processor(s) may include microcontrollers, digital signal processors (DSPs), general purpose processing units, central processing units (CPUs), graphical processing units (GPUs), application specific processors or circuits (e.g., ASICs), and logic devices (e.g., FPGAs), as well as other types of processing devices, combinations, or variations thereof.

Core images 305, 306, and 307 provided to processing core 310 are representative of application images executable by processing cores of a source or host computer system, such as processing cores 110 of system 105. Each application image includes sets of program instructions referred to as application code segments and also includes header file and PHT in accordance with the ELF format, for example. Further, each application image may correspond to a processing core among the processing cores. In other words, the program instructions of each application image are to be executed by a corresponding processing core 110 of system 105. Thus, each application image is also called “core images” in the disclosure.

As shown in FIG. 3, core image 305 includes a file header, a program header table, and several application code segments denoted as segment 11, segment 12, up to segment 1j in operating environment 300. Core image 306 includes a file header, a program header table, and several other application code segments denoted as segment 21, segment 22, up to segment 2k. Core image 307 includes a file header, a program header table, and several other application code segments noted as segment 31, segment 32, up to segment 3m. For purposes of illustration, FIG. 3 shows three core images 305, 306, and 307 and they include different numbers of application code segments. However, in various embodiments, processing core 310 may receive fewer or more than three core images, and the core images may include different or the same number of application code segments.

Processing core 310 receives core images 305, 306, and 307 and generates combined application image 312 based on the core images. More specifically, processing core 310 combines elements of each core image to generate a combined file for all of the core images. Upon the combination, processing core 310 may re-arrange the segments in a sequential order. For example, combined application image 312 may include, in sequence, a file header, a PHT, and a set of application code segments. Additionally, combined application image 312 may include a mapping segment 313 (e.g., before the application code segments) to indicate a mapping of the application code segments of core images 305-307 to the application code segments of combined application image 312. An illustrative aspect of the association between a source segment number and the destination segment number is shown in FIG. 3 with respect to the segment list of combined application image 312. As described above, in some embodiments, mapping segment 313 may further include data and/or information indicative of a boot sequence of the processing cores of the destination or system 105.

Additionally, processing core 310 may optionally generate a security header 314 for combined application image 312. In various embodiments, the security header 314 is representative of a security certificate (e.g., an X509 certificate) usable to determine the integrity of combined application image 312. In some embodiments, the security header 314 may include a signature with an asymmetric key (e.g., RSA-4K, ECDSA). Additionally, in some embodiments, the security header 314 includes an integrity value calculated by performing one or more hashing algorithms (e.g., SHA2-256, SHA2-512) on the elements of combined application image 312.

The mapping segment 313 of combined application image 312 may include data indicative of correspondence of each of the application code segments of combined application image 312 to the application code segments of core images 305-307. In some embodiments, the mapping segment 313 may additionally include a boot sequence indicative of a sequence by which the processing cores execute respective application code segments during run-time operations.

After generating combined application image 312, processing core 310 stores combined application image 312 to a memory, e.g., memory 130.

In some embodiments, prior to storing combined application image 312 on memory 130, processing core 310 may optionally encrypt a portion of combined application image 312. In particular, processing core 310 may encrypt the portion of combined application image 312 holding the application code segments (e.g., application code segments 1 to 3m). Processing core 310 may encrypt other portions of combined application image 312 in some embodiments. In this way, the file header, PHT, and mapping segment 313 may be still parsable by system 105 without decryption, so that system 105 may be able to determine the correspondence of application code segments 312 to the respective processing cores 110 and where to store each segment within an internal memory (e.g., memory 120), while encrypted segments 321 can remain confidential and protected from malicious attackers.

FIGS. 4A and 4B include methods 401 and 402, respectively, that include steps corresponding to boot sequences that may be performed by one or more processing cores 110 of system 105 and/or hardware security module 112 of system 105, and which reference elements of FIGS. 1 and 3. As such, methods 401 and 402 may be implemented as software, firmware, and/or hardware, as well as combinations or variations thereof.

Referring first to FIG. 4A, method 401 is demonstrative of an example boot sequence without a security mechanism. In various embodiments, the boot sequence refers to a sequence of operations during which hardware, software, and firmware elements of system 100 are initialized to perform run-time operations. Additionally, as described below, the boot sequence may perform a variety of operations on the segments of a combined application image in a streaming manner. For example, the boot sequence may perform one or more operations on one or more segments and then proceed to perform the operations on the next one or more segments.

To begin, in operation 410, one processing core of system 105, e.g., processing core 110-1, obtains a file header, and PHT, and/or a mapping segment (e.g., mapping segment 313) of combined application image 312 from memory (e.g., memory 130). For example, processing core 110-1 may read the file header, the PHT, and/or the mapping segment from external memory 130 and store them to internal memory 120. The file header may include data and/or information about combined application image 312, such as file type and size, the PHT may include data and/or information about application code segments thereof, such as the address, offset, and size, and the mapping segment may include data and/or information correlating the application code segments to respective processing cores. As described above, in some embodiments, the mapping segment may also include data and/or information indicative of a boot sequence of processing cores 110 of system 105.

Next, in operation 411, processing core 110-1 obtains application code segments of combined application image 312 based on the file header, the PHT, and the mapping segment. In various embodiments, this entails reading each application code segment from memory 130, then writing each application code segment to a corresponding, specific location in memory 120 based on associations identified in the data obtained in operation 410.

Next, in operation 412, processing cores 110 executes the loaded application code segments. For example, each processing core 110 may execute one or more corresponding application code segments of combined application image 312, according to the boot sequence indicated by the mapping segment.

Referring next to FIG. 4B, method 402 is demonstrative of an example boot sequence with a security mechanism. Method 402 includes several steps that may be performed by a processing core of system 105 (e.g., processing core 110-1) and by hardware security module 112 of system 105. In FIG. 4B, the steps shown on the left-hand side of the page relate to steps performed by the processing core, while the steps shown on the right-hand side of the page relate to steps performed by hardware security module 112.

To begin method 402, in operation 420, one processing core of system 105, e.g., processing core 110-1, obtains security header 314 of combined application image 312. For example, processing core 110-1 may read security header 314 and store to memory 120. In various embodiments, the security header 314 is representative of a security certificate (e.g., an X509 certificate) usable to determine the integrity of combined application image 312. In some embodiments, the security header 314 may include a signature with an asymmetric key (e.g., RSA-4K, ECDSA). Additionally, in some embodiments, the security header 314 includes an integrity value calculated by performing one or more hashing algorithms (e.g., SHA2-256, SHA2-512) on the elements of combined application image 312. Processing core 110-1 provides the security header 314 to hardware security module 112 for authentication.

In operation 421, hardware security module 112 receives security header 314 of combined application header 312 (e.g., from memory 120) and performs an authentication operation on security header 314 to determine whether a signature and/or a key associated with combined application code 312 is authentic or not. This may entail comparing an integrity value, certificate information, or other security information of security header 314 with a security value known to hardware security module 112. If authentic, hardware security module 112 proceeds to operation 422. If not authentic, hardware security module 112 may terminate operations and provide an indication to processing cores 110.

In operation 422, hardware security module 112 provides an indication of the authentication operation to processing core 110-1. The indication may be representative of an acknowledgement of completion of the authentication, as well as the success thereof.

In operation 423, processing core 110-1 obtains a file header, a PHT, and mapping segment 313 of combined application image 312 based on the indication from hardware security module 112. This may entail reading these segments of combined application image 312 from a memory (e.g., memory 130) and loading the segments into another memory (e.g., memory 120). Then, processing core 110-1 can provide the segments to hardware security module 112.

In operation 424, hardware security module 112 performs a security operation on the file header, the PHT, and the mapping segment 313. In some embodiments, hardware security module 112 performs a single security operation on the combination of segments. In some embodiments, hardware security module 112 performs individual security operations on each segment. The security operations may include hash operations or hashing algorithms applied by hardware security module 112 to determine a value (e.g., a hash value) corresponding to a respective segment.

Upon performing the security operation(s), in operation 425, hardware security module 112 provides an indication corresponding to the security operation(s) to processing core 110-1. The indication may be representative of an acknowledgement of completion of the security operation(s) and availability of a result thereof.

In operation 426, processing core 110-1 obtains a next application code segment based on the indication from hardware security module 112, and also based on the file header, the PHT, and the mapping segment 313. In various embodiments, processing core 110-1 obtains the application code segment from memory 130 in a sequential order, and store it to a specific location in memory 120, based on information indicated in mapping segment 313 and the PHT. Each application code segment may correspond to a processing core 110 of system 105. As such, in some embodiments, the sequential order may correspond to a boot sequence of processing cores 110 and/or to an order in which the application code segments are stored in combined application image 312. Processing core 110-1 provides the application code segment to hardware security module 112.

Next, in operation 427, hardware security module 112 performs a security operation on the next application code segment to determine a corresponding security value for the application code segment. Similarly, processing core 110-1 obtains a next application code segment and provides it to hardware security module 112 to perform a security operation. Thus, the loading of application code segments by processing core 110-1 and performance of the security operation on the loaded application code segments by hardware security module 112 may operate iteratively, until operation 428 when hardware security module 112 completes the security operation on the last application code segment.

In this way, hardware security module 112 performs security operations for all the application code segments as they are provided by processing core 110-1. In some embodiments, hardware security module 112 performs the same hash operation for each application code segment, thus, the hash operation is an ongoing hash operation for the duration of the boot sequence. In some embodiments, hardware security module 112 performs individual hash operations for each application code segment.

In operation 428, if hardware security module 112 determines that a current application code segment is the last application code segment of the combined application image 312, hardware security module 112 proceeds to operation 429. In operation 429, hardware security module 112 performs an integrity check of combined application image 312 based on a combination of the security operation results, e.g., as determined in above described operations 424 and 427 on the file header, PHT, mapping segment, and/or application code segments. In some embodiments, in performing the integrity check, hardware security module 112 may perform a comparison between the security result for the last application code segment and a security value identified in security header 314 to determine whether combined application image 312 is authentic or not. For example, security header 314 includes a security value with which hardware security module 112 compares against the security values. In some embodiments, hardware security module 112 may concatenate the security operation results (e.g., hashes) to form a combined security operation result (e.g., a combined hash), and compare the combined security operation result with an expected security operation result. In operation 430, if hardware security module 112 determines that the values do not match, and thus, the combined application image is not authentic (e.g., suspicious, malicious), hardware security module 112 outputs a failure indication to processing cores 110 in operation 431. This way, hardware security module 112 may authenticate the entire content of combined application image 312. If hardware security module 112 determines that the values match, hardware security module 112 determines that the combined application is authentic and proceeds to operation 432.

In operation 432, hardware security module 112 provides an indication corresponding to the integrity check to processing core 110-1. The indication may be representative of an acknowledgement of completion and success of the integrity check. In operation 433, processing core 110-1 determines whether the application code segments of combined application image 312 are encrypted or not based on security header 314, and such, whether processing core 110-1 has to decrypt the application code segments. If the application code segments are not encrypted, processing core 110-1 executes the application code segments in operation 434 such that the processing cores execute respective application code segments. If the application code segments are encrypted, processing core 110-1 decrypts the application segments in operation 435. Then, in operation 436, processing cores 110 of system 105 execute the application code segments. For example, each processing core may access and execute one or more corresponding application code segments of combined application image 312. Please note that FIG. 4B is provided only as an example for purposes of illustration. In some embodiments, the decryption may be performed by hardware security module 112 instead of processing core 110-1. For example, after operation 430, hardware security module 112 may determine whether the application code segments are encrypted, and if so, perform the decryption and then provide the indication in operation 432. Additionally, in some embodiments, encrypted application code segments may be decrypted separately instead of altogether at once. For example, if the decryption is performed by processing core 110-1, processing core 110-1 may decrypt an application code segment once it receives an indication associated with completion of the security operation on a prior segment by hardware security module 112. Similarly, if the decryption is performed by hardware security module 112, hardware security module 112 may decrypt an application code segment once it completes the security operation on the application code segment.

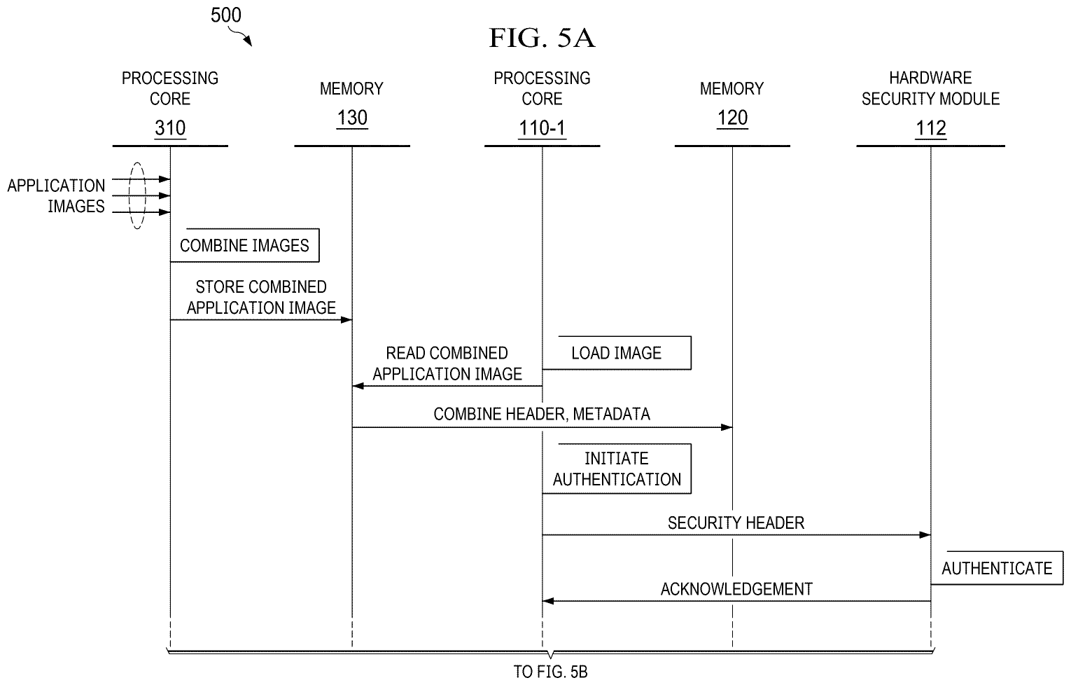

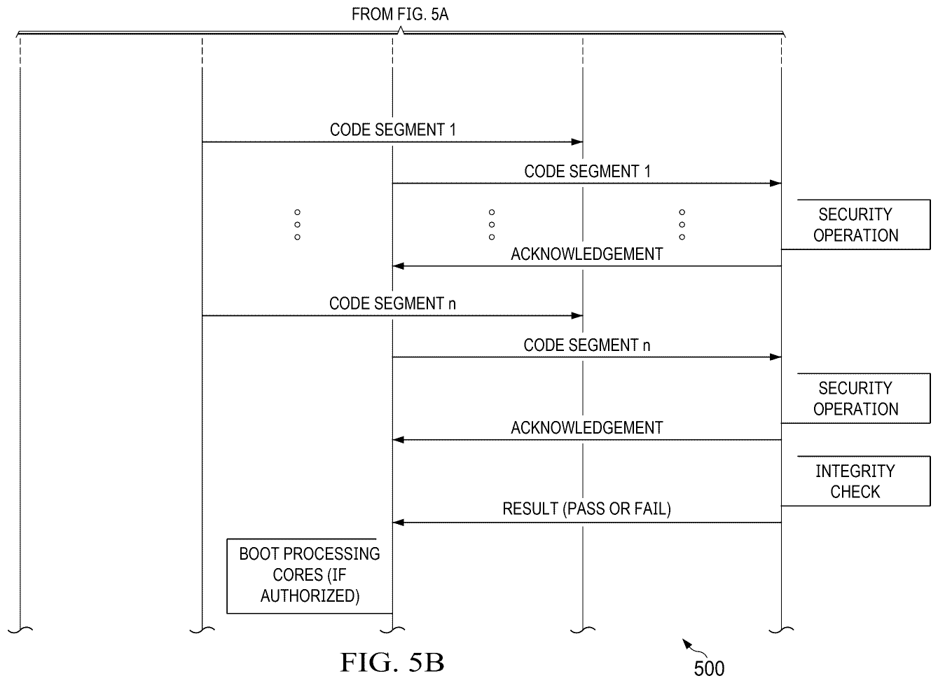

FIGS. 5A and 5B illustrate an example operational scenario 500 involving elements of system 100 and operating environment 300 where application images are stored on memory 130 by processing core 310, accessed by processing core 110-1 of system 105, and authenticated by HSM 112 of system 105.

To begin operational scenario 500, processing core 310 receives multiple application images and combines the multiple application images into a combined application image (e.g., combined application image 312). In various embodiments, the combined application image includes a single, combined file header (e.g., an ELF header) having data from each of the headers of the multiple application images, a single, combined program header table having data from each of the program header tables of the multiple application images, numerous application code segments from the multiple application images, and a mapping segment (e.g., mapping segment 313) indicative of information about the application code segments and corresponding processing cores. Additionally, the combined application image may optionally include a security header (e.g., a security certificate, e.g., security header 314) that can be used to authenticate the combined application image. After combining the application images, processing core 310 stores the combined application image on memory 130.

Subsequently, processing core 110-1 loads the combined application image from memory 130 to memory 120 of system 105. To load the combined application image to memory 120, processing core 110-1 reads the combined application image from memory 130 and writes the combined application image to memory 120. More specifically, processing core 110-1 writes the header segments to a location in memory 120, the mapping segment to a different location in memory 120, and each application code segment to a specific corresponding location in memory 120. The locations at which processing core 110-1 writes the application code segments to memory 120 may be based on the mapping segment and/or the program header table of the combined application image.

After loading the combined application image to memory 120, processing core 110-1 initiates a boot sequence of hardware security module 112 to authenticate the combined application image. During the boot sequence, processing core 110-1 provides each portion of the combined application image from memory 120 to hardware security module 112, and hardware security module 112 performs security operations on each portion of the combined application image as in method 402 of FIG. 4B described above. More specifically, processing core 110-1 may first provide the security header of the combined application image to hardware security module 112. Hardware security module 112 identifies an integrity value of the security header, compares the integrity value to a security value, and authenticates the combined application image if hardware security module 112 determines that the values match. Upon determining that the security header is authentic, hardware security module 112 may provide an acknowledgement to processing core 110-1.

Upon receiving the authentication acknowledgement, processing core 110-1 provides the application code segments to hardware security module 112 individually and in a sequential order. For example, processing core 110-1 first provides code segment 1 (a first segment) of the combined application image to hardware security module 112, then processing core 110-1 provides code segment 2 (a second segment) to hardware security module 112, and so on.

Prior to processing core 110-1 providing a subsequent application code segment, and in response to receiving a current application code segment, hardware security module 112 performs a security operation on the application code segment to determine whether the application code segment is authentic or not authentic (e.g., malicious, suspicious). In various embodiments, the security operation includes a cryptography operation, such as a hash operation. Upon performing the security operation, for a given application code segment, hardware security module 112 determines a hash value of the application code segment. Hardware security module 112 provides an acknowledgement to processing core 110-1 after performing the security operation.

Processing core 110-1 can provide the next application code segment (e.g., code segment 2) in response to receiving the acknowledgement corresponding to the previous application code segment.

Processing core 110-1 and hardware security module 112 can repeat these steps until processing core 110-1 has provided all the application code segments to hardware security module 112 and hardware security module 112 has performed a security operation on all the application code segments. After performing the security operation on the last application code segment, hardware security module 112 performs an integrity check on the combined application image. This may entail hardware security module 112 comparing the hash values determined for each of the application code segments to hash values identified in the security header to determine whether the combined application image is authentic based on a result of the comparison. This may instead entail hardware security module 112 comparing the hash value for the final application code to the hash value identified in the security header. If hardware security module 112 determines that the hash values match the hash values in the security header, then hardware security module 112 provides an indication thereof to processing core 110-1.

Processing core 110-1 receives the indication and boots processing cores 110 if the result indicates an authentication of the application code segments. As a result of booting processing cores 110, each of processing cores 110 can execute respective application code segments to enable functionality provided by the application code segments.

While processing core 310 and processing core 110-1 are shown as separate processing cores, in some embodiments, processing cores 310 and 110-1 may be the same processing core. In some embodiments, processing core 310 may instead be a different one of processing cores 110 located on system 105 (e.g., processing core 110-2), or located externally with respect to the processing cores of system 105 (i.e., processing core 310 is a host processing core). In some embodiments, however, processing core 310 may be independent of processing cores 110 of system 105.

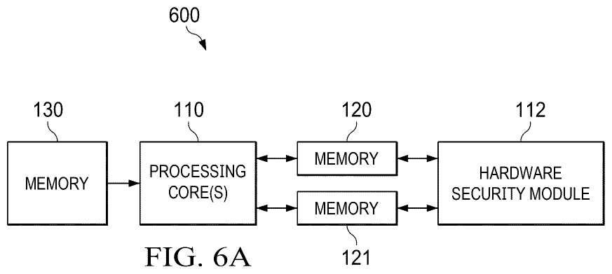

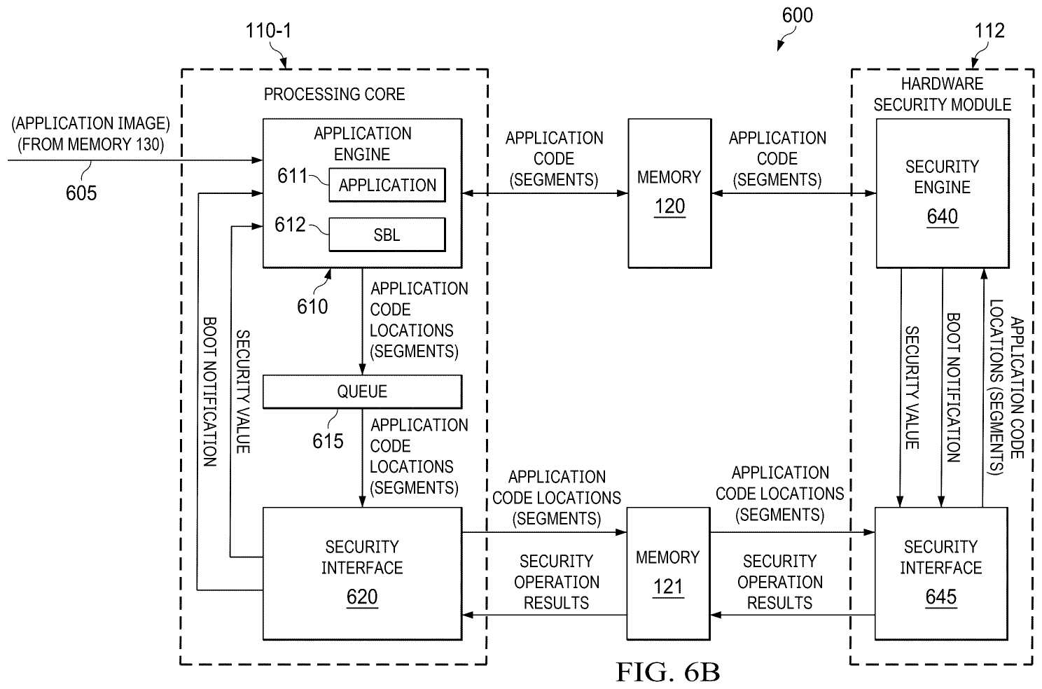

FIGS. 6A and 6B illustrate example block diagrams of elements capable of accessing and authorizing an application image from memory 130. In particular, FIG. 6A shows operating environment 600, which includes a simplified block diagram representative of a physical and logical implementation suitable for performing boot sequence processes.

FIG. 6A includes memory 130, processing core 110-1, memory 120, memory 121, and HSM 112. FIG. 6B also shows operating environment 600 with additional hardware, software, and firmware elements of processing core 110-1 and HSM 112.

Referring first to FIG. 6A, operating environment 600 shows memory 130, processing core 110-1, memory 120, memory 121, and hardware security module 112. In particular, processing core 110-1 is coupled to memory 130, memory 120 is coupled to processing core 110-1, memory 121 is coupled to processing core 110-1, and hardware security module 112 is coupled to memories 120 and 121. While not shown, an interconnect (e.g., interconnect 115) may also be included in operating environment 600, coupling processing core 110-1 to memories 120 and 121, and coupling hardware security module 112 to memories 120 and 121. Additionally, while not shown, an external memory interface controller (e.g., external memory interface controller 12) may also be included in operating environment 600 coupling processing core 110-1 to memory 130.

In operation, processing core 110-1 loads an application image (e.g., combined application image 312) from memory 130 to memory 120. This may entail reading portions of the application image from memory 130 and writing the portions to corresponding locations in memory 120. The locations of memory 120 at which processing core 110-1 writes the portions of the application image may be determined based on a mapping segment of the application image (e.g., mapping segment 313) and/or information in the PHT of the combined application image. In this way, processing core 110-1 might not load the entire application image into a temporary location in memory 120, parse locally, and then move portions of the application image from the temporary location to specific locations. Rather, processing core 110-1 can directly load the portions of the application image into specific corresponding locations. Additionally, while the application image segments may be encrypted in some embodiments, the mapping segment might not be. As a result, processing core 110-1 can reduce capacity requirements of memory 120 and increase the effective capacity of memory 120, sometimes even by 50%, as the application image segment locations are readable based on the mapping segment.

Prior to loading the application image into memory 120, processing core 110-1 provides a request to initialize a boot sequence of hardware security module 112. The boot sequence of hardware security module 112 refers to a start-up sequence during which hardware security module 112 executes program instructions stored on internal memory of hardware security module 112 (e.g., read-only memory (ROM)) to become operational and perform security operations to authenticate application code segments.

While hardware security module 112 performs the boot sequence, in an effort to parallelize activities of hardware security module 112 and processing core 110-1, and in effect, reduce latency of a boot sequence of processing cores 110, processing core 110-1 enqueues application code segments of the application image in memory 120. Further, processing core 110-1 enqueues data in queue 615, which indicates the locations of the application code segments in memory 120 and is further transferred to memory 121. Please note that FIG. 6B is provided only as an example for purposes of illustration. In various embodiments, memory 120, queue 615, and memory 121 may reside on the same or different memory devices.

Following the initialization of hardware security module 112, hardware security module 112 reads the locations from memory 121, reads the corresponding application code segments from memory 120, and performs security operations on the application code segments individually and in a sequential order. Hardware security module 112 determines whether the application code segments are authentic or not based on results of the security operations. If the application code segments are authentic, hardware security module 112 provides an authentication indication to processing core 110-1 resulting in the boot of processing cores 110. If the application code segments are not authentic, hardware security module 112 provides a failure indication to processing core 110-1 resulting in error-handling operations. However, in a boot sequence with a security mechanism shown in FIGS. 4B-5, processing core 110-1 may have to wait idly, until hardware security module 112 completes security operation(s) on a segment, prior to proceeding and loading the next segment of the combined application image. This can cause delays and slow down the boot sequence. Thus, one or more alternative boot sequence will be described below to allow loading of the combined application image by the processing cores in parallel with the security checks by the hardware security module. For example, processing core 110-1 may enqueue a first batch of segments to let hardware security module perform security operation(s). While hardware security module 112 is performing security operation(s) on the first batch, processing core 110-1 may, in parallel, continuously read and enqueue a next, second batch of segments in memory 120, until hardware security module completes the security operation(s) on the first batch. Accordingly, processing core 110-1 may pause the reading of the segments, and provide the location information of the already-enqueued second batch to hardware security module 112. In turn, hardware security module 112 may obtain the location information (e.g., from memory 121), access the enqueued second batch (e.g., from memory 120) based on the location information, and perform the security operation(s) on the second batch. This may also remove the pause on processing core 110-1, such that it may resume the reading and enqueueing of a next, third batch of segments. These operations may repeat until hardware security module completes the security operation(s) on all segments of the combined application image. The parallel operation may greatly reduce the delays of the boot sequence and thus improve efficiency and performance of the computer system.

Referring next to FIG. 6B, FIG. 6B shows a more detailed version of operating environment 600 in which processing core 110-1 includes application engine 610, queue 615, and security interface 620, and in which hardware security module 112 includes security engine 640 and security interface 645. In various embodiments, processing core 110-1 and security module 112 may include and may be implemented in hardware, software, and/or firmware, as well as combinations and variations thereof.

In various embodiments, application engine 610 is representative of a processing core, system, device, circuit, or the like capable of receiving application image 605 and executing application 611 and secondary bootloader (SBL) code 612. Application 611 is representative of a set of program instructions that, when executed by application engine 610, enable functionality provided by application 611. In some embodiments, application 611 is representative of one or more application code segments of application image 605, which may be representative of a set of program instructions as well as other header information and data structures (e.g., combined application image 312). SBL code 612 is representative of a set of program instructions that, when executed by application engine 610, enable an initialization of a boot sequence of hardware security module 112, among other elements of system 105, which may include loading the application code segments into internal RAM and enqueuing the segments for orderly verification thereof as described herein.

Queue 615 may be representative of memory or storage (e.g., a buffer) capable of storing indications of locations (e.g., addresses) of enqueued application code segments of application image 605 in memory 120 during a boot sequence.

Security interface 620 may be representative of an interface capable of providing secure inter-processor communications (IPC) between processing core 110-1, memory 121, and hardware security module 112. Hardware security module 112 includes security interface 645, which may also be representative of a similar interface for providing secure IPC between hardware security module 112, memory 121, and processing core 110-1. More specifically, in some embodiments, security interfaces 620 and 645 may be implemented as a software layer of processing core 110-1 and hardware security module 112, respectively, to perform integrity checks and permission checks on communications (e.g., messages/signals, arguments of messages/signals) between processing core 110-1 and hardware security module 112.

In communications between processing core 110-1 and hardware security module 112 via respective secure IPCs, memory 121 may function as a mailbox memory. In particular, messages from processing core 110-1 can be written to memory 121 via security interface 620, then read by hardware security module 112 from memory 121 via security interface 645. Similarly, messages from hardware security module 112 to processing core 110-1 can be written to memory 121 via security interface 645, then read by processing core 110-1 from memory 121 via security interface 620. In both instances, the recipient of a given message may be interrupted when a message is written to memory 121 causing the recipient to read the message from memory 121.

Hardware security module 112 includes security engine 640 to process messages received from processing core 110-1 at memory 121. In various embodiments, security engine 640 is representative of a processing core, system, device, circuit, or the like capable of providing security checks on data, code, and other information provided to hardware security module 112. In some embodiments, security engine 640 functions in a server-client relationship between elements (e.g., processing core 110-1) of system 105.

To initiate operations of processing core 110-1 and hardware security module 112, security engine 640 executes initialization code. In some embodiments, in executing the initialization code, security engine 640 triggers processing core 110-1 to execute the initialization code, which results in application engine 610 executing SBL code 612. Upon executing SBL code 612, application engine 610 requests security engine 640 to initiate a boot sequence of hardware security module 112. This may entail security engine 640 receiving run-time firmware from memory 130 and executing the run-time firmware. In some embodiments, the run-time code executable by security engine 640 may instead, or additionally, be software.

While security engine 640 executes the run-time firmware, application engine 610 loads application image 605 from memory 130 to memory 120. In various embodiments, application image 605 is representative of an executable file (e.g., a file in Executable and Linkable Format (ELF)), which may include a file header, a program table header (PHT), a mapping segment, and several application code segments that include program instructions. The PHT may indicate a size and location of each application code segment within application image 605, among other information, while the mapping segment may indicate a correlation between application code segments and respective processing cores. Based on the PHT and the mapping segment, application engine 610 can load application image 605 to specific corresponding locations in memory 120.

Also, while security engine 640 executes the run-time firmware, application engine 610 enqueues indications of the locations of the application code segments in queue 615. The indications of the locations identify the specific locations within memory 120 associated with each of the application code segments of application image 605. Then, application engine 610 transfers the indications of the locations from queue 615 to memory 121 via security interface 620.

Upon initialization of hardware security module 112, hardware security module 112 is operational and capable of performing run-time activities. During run-time of hardware security module 112, security engine 640 provides a boot notification indicative of the initialization of the run-time firmware to application engine 610 via security interfaces 620 and 645. When application engine 610 receives the boot notification, application engine 610 performs an interrupt service routine (ISR). In performing the ISR, application engine 610 may pause read or write operations, process the boot notification, and provide the enqueued indications of the application code segment locations from memory 121 to security engine 640. After performing the ISR, application engine 610 may continue performing read or write operations previously paused, then continue enqueuing further indications of locations into queue 615 and to memory 121.

Security engine 640 receives the indications of the application code segment locations, reads the application code segments from the corresponding locations in memory 120 based on the indications, and performs security operations on the application code segments (e.g., hash operations, cryptography operations). In some embodiments, security engine 640 performs one continuous security operation on the application code segments. In this way, for the application image, security engine 640 determines a security value for the application image and provides the security value to application engine 610 via security interfaces 620 and 645. These processes including the enqueuing of indications by application engine 610, reading of application code segments by security engine 640, and verifying of the application code segments by security engine 640 may iteratively continue until all application code segments have been processed by hardware security module 112 and verified by security engine 640 thereof.

Based on the security operation results, including indications representative of a completion of the security operations as well as security values obtained therefrom, security engine 640 and application engine 610 determine application image 605 is authentic. As a result, application engine 610 executes application 611. Other processing cores may also execute respective application code segments of application image 605 based on the authentication of application image 605.

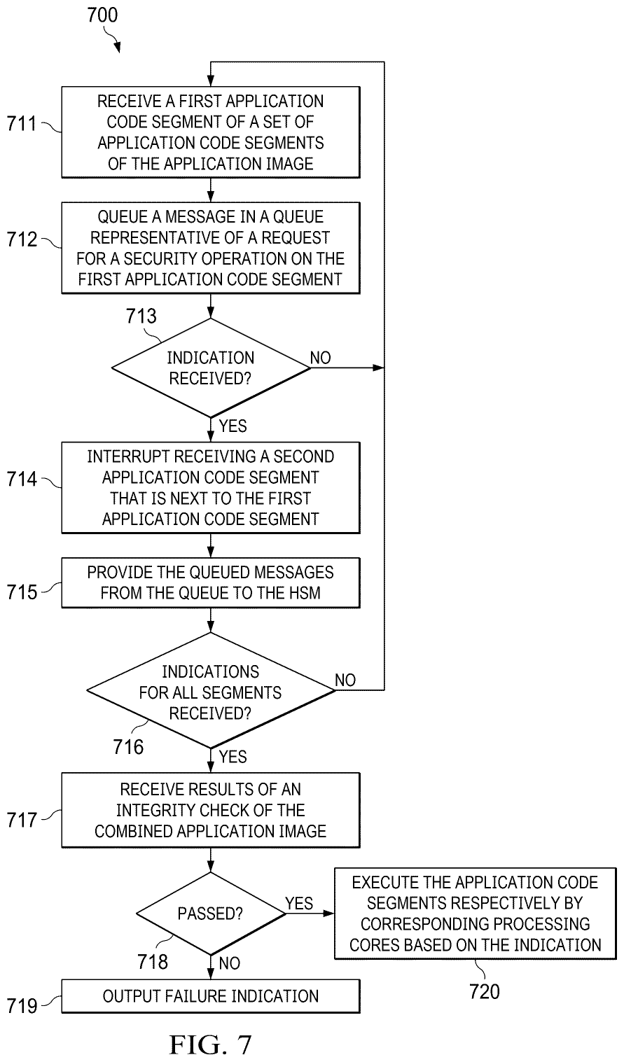

In previous solutions, only after receiving the boot notification might application engine 610 load application image 605 into memory 120 and begin to provide application code segments to hardware security module 112. Advantageously, here, application engine 610 functions in parallel with security engine 640 to enqueue the indications while security engine 640 is booting up. FIG. 7 illustrates an enhanced boot method 700 employed by processing core 110-1 to parallelize activities of processing core 110-1 and HSM 112.

Referring now to FIG. 7, method 700 may be performed by elements of system 105, such as processing core 110-1, among other processing cores. As such, method 700 may be implemented in hardware, software, and/or firmware, as well as combinations and variations thereof. Processing core 110-1 functions in the steps that follow, and that reference elements of system 100 of FIG. 1 and operating environment 600 of FIGS. 6A and 6B.

Prior to the performance of the steps of method 700, processing core 110-1 and hardware security module 112 are initialized. To initiate operations of processing core 110-1 and hardware security module 112, hardware security module 112 may first execute initialization code (e.g., firmware, secondary bootloader code). In executing the initialization code, hardware security module 112 triggers processing core 110-1 to execute initialization code, which results in processing core 110-1 executing SBL code (e.g., SBL code 512). Upon executing SBL code, processing core 110-1 requests hardware security module 112 to initiate a boot sequence to bring hardware security module 112 to a run-time operational mode. Upon receiving the request to initiate the boot sequence, hardware security module 112 may obtain run-time firmware from memory 130 and execute the run-time firmware.

As described above, in some embodiments, processing core 110-1 may obtain a security header, a file header, a PHT, and/or a mapping segment of a combined application image; and hardware security module 112 may perform security operation(s) on these segments. For example, hardware security module 112 may verify a key of the security header and perform hashing operations on the file header, the PHT, and the mapping segment.

While hardware security module 112 is executing the run-time firmware to boot-up, processing core 110-1, in operation 711, receives a first application code segment of a combined application image (e.g., combined application image 312) from memory 130. In various embodiments, this first application code segment refers to one of a file header, a PHT, a mapping segment, and an application code segment of a set of application code segments of the combined application image. In such embodiments, processing core 110-1 obtains the first application code segment according to an order in which the combined application image is organized. In particular, during the first iteration of operation 711, the first application code segment corresponds to a file header of the combined application image. The second application code segment may correspond to the PHT, the third application code segment may correspond to the mapping segment, the fourth application code segment may correspond to a first segment of the application code segments, and so on.

In operation 712, for the first application code segment, processing core 110-1 enqueues a message in queue 615. The message may indicate a request for a security operation on the first application code segment. Further, the message may include data indicative of locations of the segments enqueued in memory 120.

In operation 713, processing core 110-1 determines whether an indication has been provided by hardware security module 112. For a first iteration through a subset of steps of method 700, the indication corresponds to a completion of the initialization sequence of hardware security module 112. For example, the indication may indicate completion of the authentication of the security header and/or the hashing operations of the file header, the PHT, and the mapping segment, as they are the first batch of segments loaded by processing core 110-1. For subsequent iterations through a subset of steps of method 700, the indication corresponds to a completion of a security operation performed on an application code segment by hardware security module 112. For example, the indication may indicate completion of the hashing operation on an application code that was loaded prior to the first application code segment. In other words, that application code segment is part of a batch of segments that was loaded prior to the current batch of the first application code segment. In some embodiments, hardware security module 112 outputs individual indications for each security operation performed on each application code segment. In some embodiments, hardware security module 112 outputs a single indication for a subset or batch of the application code segments.

In operation 713, if processing core 110-1 has not received the indication corresponding to the completion of the initialization sequence, processing core 110-1 repeats operations 711 and 712 for subsequent application code segments in accordance with the sequential order as indicated by the PHT and/or the mapping segment of the combined application image. In this way, processing core 110-1 can continue queuing application code segments to operate in parallel with hardware security module 112 saving time.

In operation 713, if processing core 110-1 receives an indication from hardware security module 112 corresponding to the completion of the initialization sequence, processing core 110-1 proceeds to operation 714. In operation 714, processing core 110-1 performs an interrupt service routine (ISR) to interrupt receiving the second application code segment (or a subsequent application code segment if operations 711 and 712 have repeated at this point) following the first application code segment. Please know that FIG. 7 is provide as an example for purposes of illustration. In some embodiments, the pause of the receiving of the second application code segment may not necessarily be performed through an ISR.

Next, in operation 715, processing core 110-1 provides the queued message associated with the first application code segment from queue 615 to hardware security module 112. Hardware security module 112 receives the queued message, identifies a location of the corresponding application code segment in memory 120, obtains the application code segment from memory 120 based on the location, and performs the security operation on the application code segment. Then, hardware security module 112 provides an indication representative of a completion of the security operation to processing core 110-1. It follows that after the output of this indication, processing core 110-1 can repeat operations 711-715, or combinations thereof, to queue subsequent application code segments, and provide queued messages associated with the subsequent application code segments to hardware security module 112 for hardware security module 112 to perform security operations on all the application code segments.

Accordingly, in operation 716, if processing core 110-1 has not received an indication of completion of the security operation on all the application code segments, processing core 110-1 proceeds to operation 711. By way of example, at this time, processing core 110-1 receives the second application code segment in operation 711, then queues a message in queue 615 corresponding to the second application code segment in operation 712. Once processing core 110-1 receives the indication of completion of the security operation corresponding to the first application code segment previously provided to hardware security module 112, processing core 110-1 interrupts receiving a third application code segment next to the second application code segment in operation 714. Then, processing core 110-1 provides the queued message related to the second application code segment to hardware security module 112 for performance of the security operation thereon.

Eventually, hardware security module 112 performs security operations on all the application code segments and provides corresponding indications to processing core 110-1. After hardware security module 112 performs the security operations on all the application code segments, hardware security module 112 performs an integrity check on the combined application image based on a combination of the security operation results. In various embodiments, this entails hardware security module 112 comparing the security operation results with a security value indicated in a security header of the combined application image. Hardware security module 112 provides an indication (e.g., an acknowledgement of completion of the integrity check) associated with the integrity check to processing core 110-1.

In operation 717, processing core 110-1 receives the indication associated with the integrity check, and in operation 718, processing core 110-1 determines whether the combined application image passes the integrity check based on the indication. If not, processing core 110-1 outputs a failure indication to other processing cores of system 105 in operation 719. If processing core 110-1 determines the integrity check was successful, processing core 110-1 executes the application code segments via corresponding processing cores in operation 720.

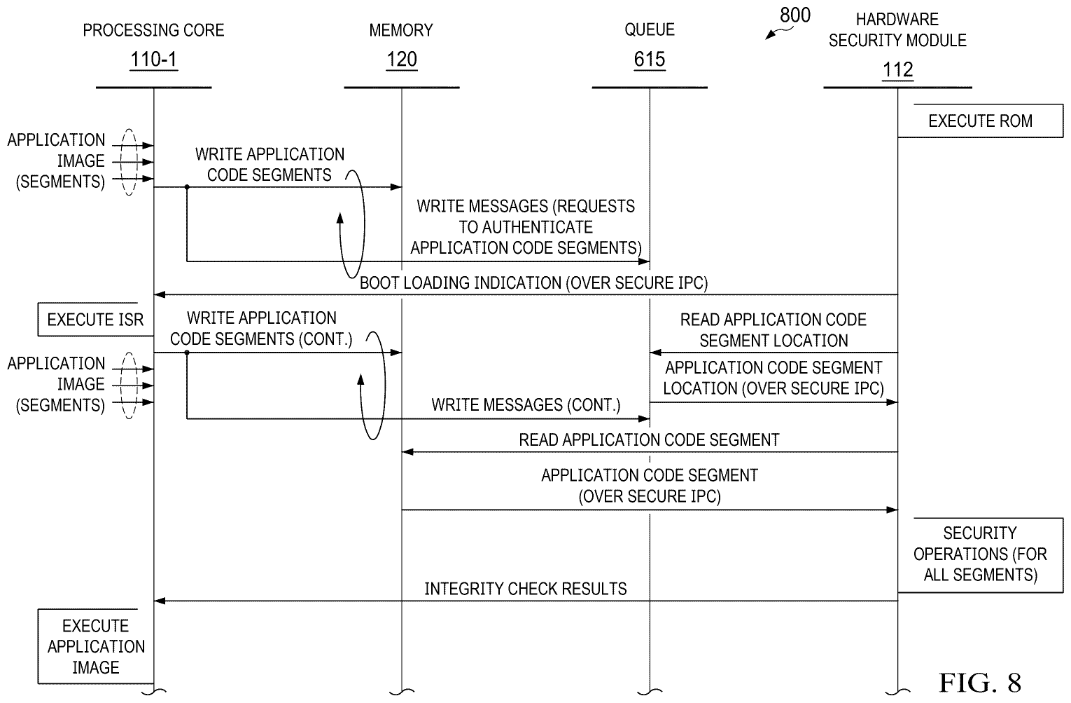

FIG. 8 illustrates an example operational scenario 800 involving elements of system 100 and operating environment 600 where application image segments are queued while HSM 112 initializes, then authenticated to boot processing cores of system 105 to execute the application image(s).

To begin operational scenario 800, processing core 110-1 requests a boot of hardware security module 112 to bring hardware security module 112 to a run-time operational mode. Upon receiving the request to initiate the boot sequence, hardware security module 112 may obtain run-time firmware (e.g., boot code) from memory 130 and execute the run-time firmware.

While hardware security module 112 is executing the run-time firmware to boot-up, processing core 110-1 reads application code segments of an application image (e.g., application image 505, combined application image 312) from memory 130 and loads the application code segments to memory 120. Next, processing core 110-1 queues indications of the locations of the application code segments in memory 121 for use by hardware security module 112 after hardware security module 112 completes the execution of the run-time firmware, boots, and outputs an indication thereof to processing core 110-1. The indications of the locations identify the specific locations within memory 120 associated with each of the application code segments of the application image, and thus, can be used to obtain corresponding application code segments from memory 120.

If hardware security module 112 has not completed the execution of the run-time firmware yet, processing core 110-1 can continue to load portions of the application image into memory 120 and enqueue application code segments of the application image into memory 121. If hardware security module 112 has booted, however, hardware security module 112 provides a boot notification to processing core 110-1 over a secure IPC channel (e.g., via security interface 545). Upon receiving the boot notification, processing core 110-1 executes an ISR. In some embodiments, the ISR may entail interrupting or pausing a read from memory 130 and processing the boot notification. Then, in response to performing the ISR, processing core 110-1 may continue to load and queue application code segments to memories 120 and 121, respectively, and/or provide queued application code segments to hardware security module 112.

After completing the execution of the run-time firmware, processing core 110-1 provides queued application code segments to hardware security module 112. This may entail hardware security module 112 receiving the indications of the locations of the application code segments via memory 121 via a secure IPC channel (e.g., via security interface 545), then hardware security module 112 reading the application code segments from memory 120 based on the indications of the locations. In various embodiments, hardware security module 112 receives the application code segments from memory 120.

For each application code segment received, hardware security module 112 performs a security operation (e.g., a hash operation, a cryptography operation) on the application code segment. Based on the results of the security operation, in operation 715, processing core 110-1 receives indications for each application code segment indicative of a successful authentication of the application code segment. The indications may include security values with which hardware security module 112 and/or processing core 110-1 may verify the authenticity and integrity of a given application code segment.

As processing core 110-1 receives application code segments, processing core 110-1 determines whether processing core 110-1 has received authentication indications for all of the application code segments. If not, processing core 110-1 can continue to load and enqueue application code segments, if necessary, and/or provide queued application code segments to hardware security module 112 to continue the operations described above. Once processing core 110-1 has received authentication indications for all the application code segments, processing core 110-1 executes the application image or respective application code segments thereof.

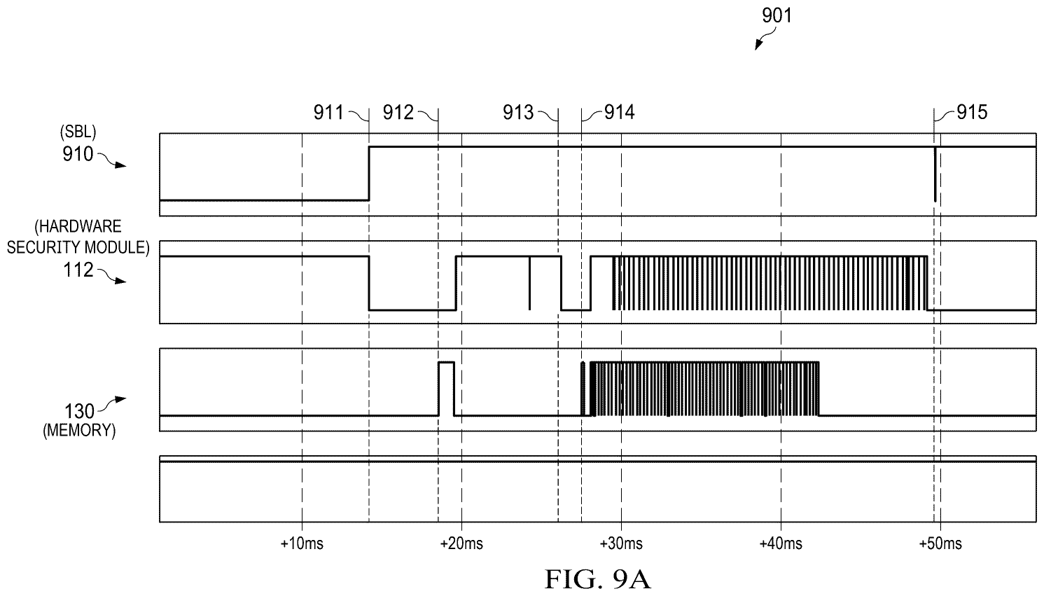

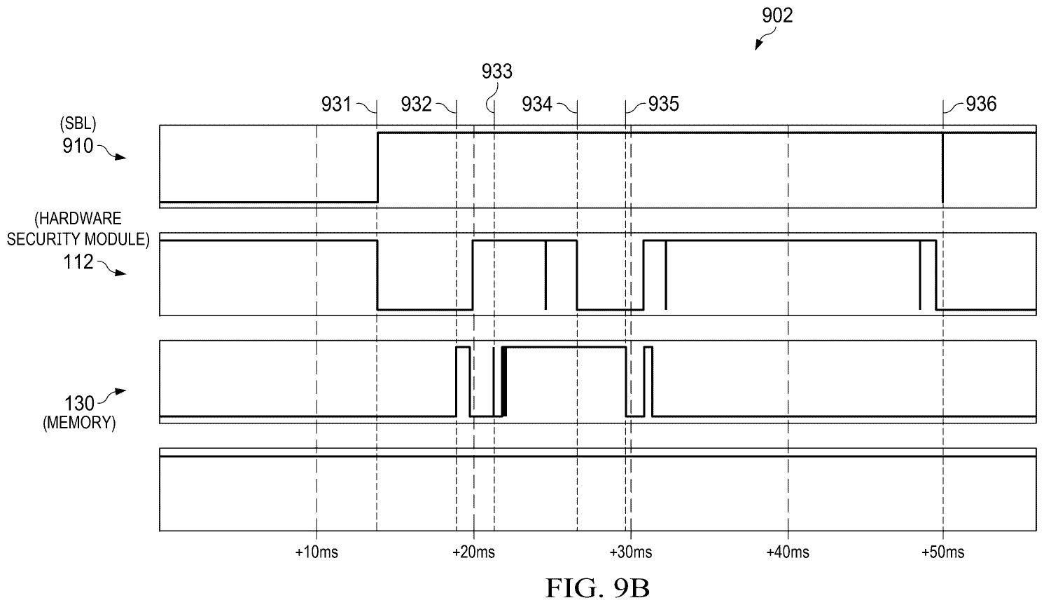

FIGS. 9A and 9B illustrate example graphical representations of output signals measured at elements of system 105 over time. FIG. 9A includes graphical representation 901, and FIG. 9B includes graphical representation 902, each of which include logical state representations indicative of activity and/or outputs produced by elements of system 100, such as hardware security module 112 and memory 130. Additionally, the graphical representations show secondary bootloader (SBL) 910, which represents a state of SBL operations indicative of a start and finish of a boot sequence of hardware security module 112 and a processing core of the system (e.g., processing core 110-1).

Referring first to FIG. 9A, graphical representation 901 is representative of activity of a system that does not parallelize boot operations during a boot sequence involving hardware security module 112 and processing cores 110 of system 105. In other words, graphical representation 901 shows logical state representations of an existing/conventional system as opposed to one implementing boot sequence methods described herein, such as method 700 of FIG. 7.

In graphical representation 901, at time 911, SBL 910 transitions from a low logical state (e.g., 0) to a high logical state (e.g., 1) indicative of the start of an initialization of hardware security module 112. At this time, processing core 110-1, for example, directs hardware security module 112 to execute code (e.g., firmware) to bring hardware security module 112 to a run-time mode. Based on receiving the request, hardware security module 112, at time 912, reads the code from memory 130, hence graphical representation 901 depicts activity at memory 130 at time 912.

Upon completion of the execution of the code, hardware security module 112 outputs a boot notification at time 913 indicative that hardware security module 112 is operable in the run-time mode. Shortly after, at time 914, processing core 110-1 begins loading an application image from memory 130 to internal memory (e.g., memory 120) and provides portions of the application image to hardware security module 112 for verification thereof (e.g., via security operations). Accordingly, between time 914 and the end of the boot sequence (time 915), there is a high amount of activity between hardware security module 112 and memory 130 depicted by transitions from low logical states to high logical states, and by transitions from high logical states to low logical states.

At time 915, hardware security module 112 completes all the security operations on the application image and outputs a final authentication indication to processing core 110-1. Processing core 110-1, among other processing cores, can then execute the application image.

Referring next to FIG. 9B, graphical representation 902 is representative of activity of a system that parallelizes boot operations during a sequence involving hardware security module 112 and processing cores 110 of system 105. In other words, graphical representation 902 shows logical state representations of a disclosed system that may implement method 700 of FIG. 7.

In graphical representation 902, at time 931, SBL 910 transitions from the low logical state to the high logical state indicative of the start of an initialization of hardware security module 112. At this time, processing core 110-1, directs hardware security module 112 to execute code (e.g., firmware) to bring hardware security module 112 to a run-time mode. Based on receiving the request, hardware security module 112, at time 932, reads the code from memory 130, hence graphical representation 902 depicts activity at memory 130 at time 932.

At time 933, before completion of the execution of the code, or in other words, in parallel with the execution of the code by hardware security module 112, processing core 110-1 beings loading segments of application code of the application image from memory 130 to a queue (e.g., queue 515, memory 121), thus graphical representation 902 depicts activity at memory 130 at this time. Then, at time 934, hardware security module 112 outputs a boot notification to processing core 110-1 to indicate that hardware security module 112 is operable in the run-time mode. Shortly after, at time 935, processing core 110-1 provides the enqueued segments from the queue to hardware security module 112 for authentication thereof. Processing core 110-1 can continue to enqueue segments from memory 130, and hardware security module can iteratively verify the segments until time 936.

At time 936, hardware security module 112 completes all the security operations on the application image and outputs a final authentication indication to processing core 110-1. Processing core 110-1, among other processing cores, can then execute the application image. By parallelizing the activity of processing core 110-1 and hardware security module 112, time 936 may be sooner than time 915 of graphical representation 901 as the amount of idle time incurred by processing core 110-1 and hardware security module 112 may be reduced, and thus, hardware security module 112 can begin authentication operations earlier than in existing/conventional systems.

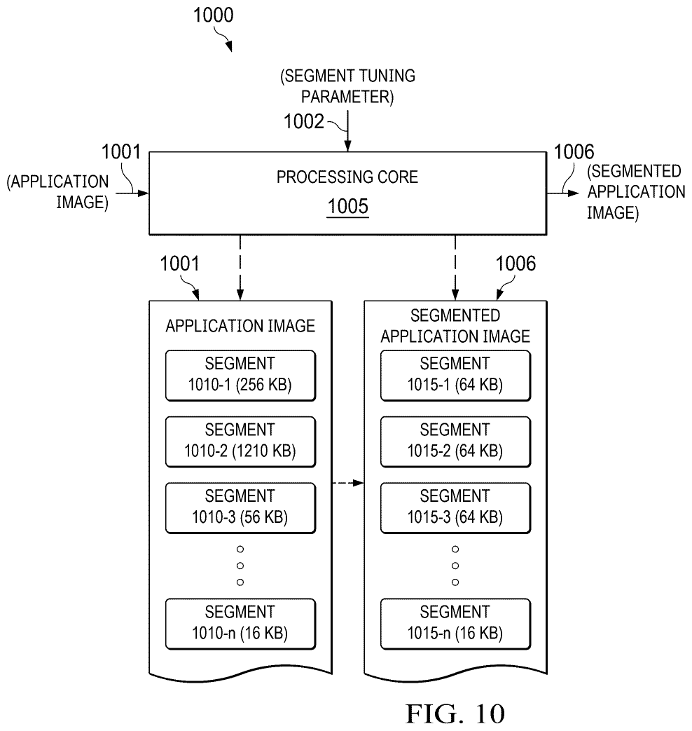

FIG. 10 illustrates operating environment 1000 in which processing core 1005 receives application image 1001 and outputs segmented application image 1006 based on segment tuning parameter 1002.

Processing core 1005 is representative of one or more processors, processing cores, or processing circuitry capable of executing software and firmware, such as program instructions (e.g., application code, loadable instructions, read-only data, execute-in-place XIP) code, and the like). Examples of such processor(s) may include microcontrollers, digital signal processors (DSPs), general purpose processing units, central processing units (CPUs), application specific processors or circuits (e.g., ASICs), and logic devices (e.g., FPGAs), as well as other types of processing devices, combinations, or variations thereof. In some embodiments, processing core 1005 is representative of a processing core external to system 105, such as processing core 310. As such, processing core 1005 may be capable of performing application image combination operations and boot operations, such as one or more of methods 401 and 402 of FIGS. 4A and 4B, respectively, and method 700 of FIG. 7.

In operating environment 1000, processing core 1005 is provided with application image 1001 and segment tuning parameter 1002 as inputs. In various embodiments, application image 1001 is representative of an executable file (e.g., a file in Executable and Linkable Format (ELF)) (e.g., application image 505, combined application image 312, core images 305, 306, and 307), which may include a file header (e.g., an ELF file header), a program table header, a mapping segment, and several application code segments that include program instructions. The program header table may indicate a size and location of each application code segment within application image 1001, among other information, while the mapping segment may indicate processing core-specific addresses corresponding to processing cores and associated application code segments.

As illustrated, application image 1001 includes segments 1010-1, 1010-2, 1010-3, and 1010-n. Segment 1010-1 is representative of a first application code segment having a size of 256 KB, segment 1010-2 is representative of a second application code segment having a size of 128 KB, segment 1010-3 is representative of a third application code segment having a size of 56 KB, and segment 1010-n is representative of an n-th application code segment having a size of 16 KB. Problematically, for large segments, the time required to read and load the segments from external memory (e.g., memory 130) into internal memory (e.g., memory 120) of a computer system is significant and can introduce latency with respect to a boot sequence.

To reduce the time required to load segments into internal memory, and thereby reduce the duration of the boot sequence, processing core 1005 uses segment tuning parameter 1002 to re-size the segments of application image 1001. In various embodiments, segment tuning parameter 1002 is representative of a parameter indicative of a target size for the application code segments of application image 1001. In some such embodiments, segment tuning parameter 1002 may specify a target size for each application code segment. In some such embodiments, segment tuning parameter 1002 may specify target sizes for subsets or ranges of application code segments (e.g., a first size for a first subset of application code segments and a second size for a second subset of application code segments). By way of example, segment tuning parameter 1002 may indicate a target size of 64 KB for a first subset of application code segments and a target size of 16 KB for a second subset of application code segments.

Based on segment tuning parameter 1002, processing core 1005 generates segmented application image 1006. To generate segmented application image 1006, processing core 1005 may re-organize and segment application image 1001 into 64 KB segments, such that a first subset of application code segments of application image 1001 are split into equal size segments. In this way, some segments of application image 1001 may be split into smaller segments, while other segments may be combined with portions of other segments to form larger segments. For example, processing core 1005 may split segment 1010-1 into four 64 KB segments and segment 1010-2 into two 64 KB segments, while creating one 64 KB segment using segment 1010-3 and a portion of another segment. As a result, processing core 1005 generates segmented application image 1006 that includes segments 1015-1, 1015-2, 1015-3, and other segments each having a size of 64 KB, and segment 1015-n having a size of 16 KB. Conversely, if segments are too small, processing core 1005 may combine them into one single segment with a size close to a size threshold. For example, processing core 1005 may combine several segments, each less than 64 KB, into one single segment having a size less than but close to 64 KB. In this way, a processing core of the computer system (e.g., processing core 110-1) can load the segments of segmented application image 1006 into internal memory of the computer system more quickly relative to application image 1001, which may reduce the duration of the boot sequence.

Other tuning parameters including different sizes or combinations of sizes may be contemplated. Regardless, processing core 1005 can advantageously distribute program instructions of application code segments among equally sized application code segments to reduce bottlenecking when loading application images from external memory (e.g., memory 130) to internal memory of a computer system (e.g., memory 120 of system 105).

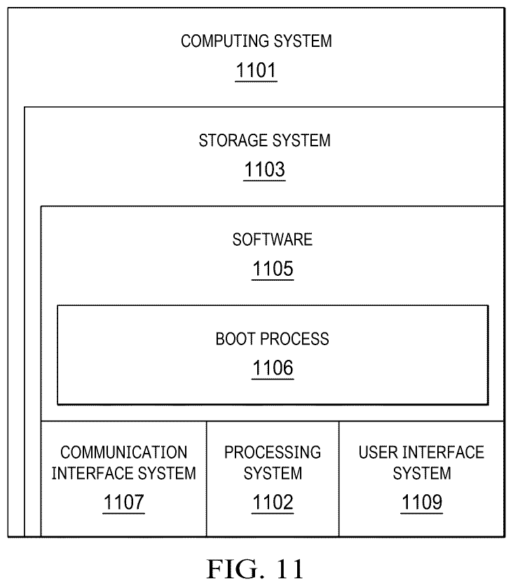

FIG. 11 illustrates computing system 1101, which is representative of any system or collection of systems in which the various applications, processes, services, and scenarios disclosed herein may be implemented. Examples of computing system 1101 include, but are not limited to server computers, web servers, cloud computing platforms, and data center equipment, as well as any other type of physical or virtual server machine, container, and any variation or combination thereof. (In some embodiments, computing system 1101 may also be representative of desktop and laptop computers, tablet computers, smartphones, and the like.)

Computing system 1101 may be implemented as a single apparatus, system, or device or may be implemented in a distributed manner as multiple apparatuses, systems, or devices. Computing system 1101 includes, but is not limited to, processing system 1102, storage system 1103, software 1105, communication interface system 1107, and user interface system 1109. Processing system 1102 is operatively coupled with storage system 1103, communication interface system 1107, and user interface system 1109.

Processing system 1102 loads and executes software 1105 from storage system 1103. Software 1105 includes and implements boot process 1106, which is representative of the processes discussed with respect to the preceding Figures. When executed by processing system 1102, software 1105 directs processing system 1102 to operate as described herein for at least the various processes, operational scenarios, and sequences discussed in the foregoing implementations. Computing system 1101 may optionally include additional devices, features, or functionality not discussed for purposes of brevity.

Referring still to FIG. 11, processing system 1102 may include a microprocessor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, microcontroller units, graphical processing units, application specific processors, integrated circuits, application specific integrated circuits, and logic devices, as well as any other type of processing device, combinations, or variations thereof.

Storage system 1103 may comprise any computer readable storage media readable by processing system 1102 and capable of storing software 1105. Storage system 1103 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 1103 may be implemented as a single storage device but may also be implemented across multiple storage devices or sub-systems co-located or distributed relative to each other. Storage system 1103 may comprise additional elements, such as a controller capable of communicating with processing system 1102 or possibly other systems.

Software 1105 (including boot process 1106) may be implemented in program instructions and among other functions may, when executed by processing system 1102, direct processing system 1102 to operate as described with respect to the various operational scenarios, sequences, and processes illustrated herein. For example, software 1105 may include program instructions for implementing application image combination, segmentation, execution, storage, as well as processing core boot, security module boot, and authentication and validation processes and procedures as described herein.

While some examples provided herein are described in the context of a system-on-chip, processor, microcontroller unit, circuitry, environment, or the like, the application image combination, encryption, decryption, authentication, validation, and boot methods, techniques, and systems described herein are not limited to such examples and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in various embodiments,” “in some embodiments,” “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
identifying multiple application images corresponding to multiple processing cores of a computer system, wherein each application image comprises a set of application code segments corresponding to a respective processing core of the multiple processing cores;
generating a combined application image based on the multiple application images, wherein the combined application image comprises a set of application code segments corresponding to the set of application code segments of each application image of the multiple application images, and a mapping segment indicative of correlations between the set of application code segments of the combined application image and the set of application code segments of each application image; and
storing the combined application image on an external memory relative to the computer system.

2. The method of claim 1, further comprising generating a security header for the combined application image which includes a key associated with encryption.

3. The method of claim 2, wherein the key is a public key associated with asymmetric encryption or a symmetric key associated with symmetric encryption.

4. The method of claim 1, wherein the combined application image comprises a combined header including an Executable and Linkable File (ELF) header and a program header table.

5. The method of claim 1, wherein generating the combined application image comprises encrypting the set of application code segments of the combined application image.

6. The method of claim 5, wherein generating the combined application image comprises not encrypting the mapping segment of the combined application image.

7. The method of claim 1, further comprising storing the combined application image from the external memory to an internal memory of the computer system.

8. The method of claim 7, wherein storing the combined application image comprises storing the set of application code segments of the combined application image in a sequential order to respective locations in the internal memory.

9. The method of claim 8, wherein storing the application code segments in the sequential order comprising determining a hash value for each application code segment of the set of application code segments of the combined application image in the sequential order.

10. The method of claim 9, further comprising determining whether a combination of the hash values of the set of application code segments matches an expected hash value.

11. The method of claim 10, further comprising decrypting the set of application code segments of the combined application image based on the combination of the hash values matching the expected hash value.

12. The method of claim 1, wherein the mapping segment includes data indicative of a sequence by which the set of application code segments of the combined application image is executed by the multiple processing cores.

13. An apparatus comprising:
a processing core configured to:
identify multiple application images corresponding to multiple processing cores of a computer system, wherein each application image comprises a set of application code segments corresponding to a respective processing core of the multiple processing cores;
generate a combined application image based on the multiple application images, wherein the combined application image comprises a set of application code segments corresponding to the set of application code segments of each application image of the multiple application images, and a mapping segment indicative of correlations between the set of application code segments of the combined application image and the set of application code segments of each application image; and
store the combined application image on an external memory relative to the computer system.

14. The apparatus of claim 13, wherein the processing core is configured to generate a security header for the combined application image which includes a key associated with encryption.

15. The apparatus of claim 14, wherein the key is a public key associated with asymmetric encryption or a symmetric key associated with symmetric encryption.

16. The apparatus of claim 13, wherein the processing core is configured to encrypt the set of application code segments of the combined application image.

17. The apparatus of claim 13, wherein the processing core is configured to generate an Executable and Linkable File (ELF) header and a program header table for the combined application image.

18. The apparatus of claim 17, wherein the processing core is configured to not encrypt the ELF header and the program header table of the combined application image.

19. The apparatus of claim 13, wherein the mapping segment includes data indicative of a sequence by which the set of application code segments of the combined application image is executed by the multiple processing cores.

20. The apparatus of claim 13, wherein the processing core is configured to arrange the set of application code segments in an order based on the sequence indicated by the mapping segment.
